(19) United States
(12) Patent Application Publication
(10) Pub. No.: US 2026/0233321 A1
(43) Pub. Date: Aug. 13, 2026

(54) REFLOW JIG DESIGNS AND RELATED METHODS

(71) Applicant: SEMICONDUCTOR COMPONENTS INDUSTRIES, LLC, Scottsdale, AZ (US)

(72) Inventors: Haijun ZHAO, Jiading (CN); Kun FENG, Shanghai (CN); Yan YANG, Suzhou (CN); Ian Ceazar Bucayon BARIAS, Butuan City (PH); Jackie JI, Suzhou (CN)

(73) Assignee: SEMICONDUCTOR COMPONENTS INDUSTRIES, LLC, Scottsdale, AZ (US)

(21) Appl. No.: 19/049,380

(22) Filed: Feb. 10, 2025

(51) Int. Cl. B23K 3/08; B23K 101/40

(52) U.S. Cl. CPC B23K 3/087; B23K 2101/40

(57) ABSTRACT

Implementations of a jig may include at least one pocket that may include an opening through a thickness of the jig; and a plurality of chamfered corner openings where each of the plurality of chamfered corner openings is located at a corner of the at least one pocket arranged around the opening. The pocket may include angled sides of the opening. The at least one pocket may be formed in a body portion of the jig.

### BACKGROUND

### 1. Technical Field

Aspects of this document relate generally to jigs, such as jigs for processing semiconductor substrates and packages. More specific implementations involve jigs employed in supporting semiconductor substrates during reflow operations.

### 2. Background

Various semiconductor packages designs have been devised that help provide mechanical support to various semiconductor die included in the packages. Other semiconductor packages work to protect a semiconductor die included in the packages from shock or vibration. Yet other semiconductor packages assist with preventing electrostatic discharge from damaging the semiconductor die.

### SUMMARY

Implementations of a jig may include at least one pocket that may include an opening through a thickness of the jig; and a plurality of chamfered corner openings where each of the plurality of chamfered corner openings is located at a corner of the at least one pocket arranged around the opening. The pocket may include angled sides of the opening. The at least one pocket may be formed in a body portion of the jig.

Implementations of a jig may include one, all, or any of the following:

An angle of the angled sides may be 13 degrees from vertical.

The chamfer on each side of the plurality of chamfered corner openings may include a rounded edge.

The opening may include only one reentrant opening in a side thereof.

The guide disposed along an edge of the opening may include a completely angled side.

An angle of the completely angled side may be 13 degrees from vertical.

Implementations of a jig may include at least one pocket including angled sides around an opening, an angle of each of the angled sides being 13 degrees from vertical. The at least one pocket may be formed in a body portion of the jig and configured to receive a semiconductor substrate therein during a reflow process.

Implementations of a jig may include one, all, or any of the following:

The jig may include at least one chamfered corner opening located at a corner of the at least one pocket.

The chamfer on a side of the at least one chamfered corner openings may include a rounded edge.

The at least one chamfered corner opening may include an arc coupled with the rounded edge.

The opening may include only one reentrant opening in a side thereof.

The guide disposed along an edge of the opening may include a completely angled side.

An angle of the completely angled side may be 13 degrees from vertical.

The jig may include three guides disposed along edges of the opening, each guide of the three guides including a completely angled side.

Implementations of a jig may include at least one pocket including an opening; and a frame including a pliant material coupled into the opening. The at least one pocket may be formed in a body portion of the jig. The frame may be configured to receive a semiconductor substrate thereon during a reflow process.

Implementations of a jig may include one, all, or any of the following:

The frame may be held in the opening using an adhesive.

The frame may be held in the opening using one or more springs welded to the opening, the one or more springs located between the opening and the frame.

The pliant material may be one of a high temperature rubber, a polyimide, or a silicone.

The surface of the frame configured to receive the semiconductor substrate thereon may be positioned in the opening to allow corners of the semiconductor substrate to extend into one or more chamfered corner openings of the at least one pocket.

The frame may include a gap aligned with a reentrant opening in a side of the opening.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations will hereinafter be described in conjunction with the appended drawings, where like designations denote like elements, and:

FIG. 1 is a side cross sectional view of a reflow jig engaged with a release jig during release of a semiconductor substrate from a pocket of the reflow jig;

FIG. 2 is a perspective view of an implementation of a pocket of a reflow jig;

FIG. 3 is a perspective view of an implementation of a pocket of another implementation of a reflow jig;

FIG. 4 is a detail perspective view of a portion of a pocket of the reflow jig of FIG. 3;

FIG. 5 is a side cross sectional view of an implementation of a pocket of a reflow jig with a semiconductor substrate coupled therein;

FIG. 6 is a top view of an implementation of a corner opening of the pocket of FIG. 2;

FIG. 7 is a top view of another implementation of a corner opening with a chamfer on each side of the pocket of FIG. 3;

FIG. 8 is a top view of an implementation of a reflow jig;

FIG. 9 is a perspective view of an implementation of a frame coupled in a pocket of an implementation of a reflow jig;

FIG. 10 is a top view of another implementation of a frame coupled in a pocket of an implementation of a reflow jig; and

FIG. 11 is a top view of an implementation of a reflow jig that includes frames.

### DESCRIPTION

This disclosure, its aspects and implementations, are not limited to the specific components, assembly procedures or method elements disclosed herein. Many additional components, assembly procedures and/or method elements known in the art consistent with the intended jigs will become apparent for use with particular implementations from this disclosure. Accordingly, for example, although particular implementations are disclosed, such implementations and implementing components may comprise any shape, size, style, type, model, version, measurement, concentration, material, quantity, method element, step, and/or the like as is known in the art for such jigs, and implementing components and methods, consistent with the intended operation and methods.

Various semiconductor packages include one or more substrates as a component of the packages. The substrates can be formed using various materials and may be, by non-limiting example, direct bonded copper (DBC) substrates, active metal brazed (AMB) substrates, aluminum nitride substrates, alumina substrates, insulated metal substrates (IMS), leadframes, any combination thereof, or any other substrate type. One or more semiconductor die are coupled to the substrates (semiconductor substrates) which may be formed of various semiconductor materials including, by non-limiting example, silicon, silicon carbide, silicon on insulator, gallium nitride, gallium arsenide, ruby, sapphire, wide band gap materials, or any other semiconductor substrate type. A wide variety of semiconductor die including various semiconductor device types may be included in the various semiconductor package implementations disclosed herein including, by non-limiting example, power semiconductor devices, diodes, metal oxide field effect transistors (MOSFETs), insulated gate bipolar transistors (IGBTs), high electron mobility transistors (HEMTs), processors, microprocessors, memory, rectifiers, hybrid devices, or any other semiconductor device type.

In various package implementations, the substrates may include one or more traces in one or more layers thereon. In various implementations, the substrates may include a combination of one or more electrically conductive layers with one or more electrically insulative layers. In some substrate implementations, a top layer of the substrate is exposed after package formation; in others, a mold compound or potting compound may cover the top layer. For packages where a mold compound is employed with the substrate, the mold compound may cover various surfaces of the substrate to help form electrically insulated areas. In various package implementations, various electrical connectors may be employed to form electrical connections between to the substrate and the one or more semiconductor die included therein including, by non-limiting example, wire bonds, clips, leads, pins, or any other electrical connector type.

In various semiconductor package implementations, the package may include a combination of a substrate with another substrate or with a leadframe in order to form the desired mechanical/electrical configuration. Where the semiconductor package includes a leadframe attached to a substrate using a solder material, the solder may first be applied to the substrate and then the leadframe may be held against/supported on the substrate during a reflow operation using a reflow oven/system that melts the solder and forms a permanent joint between the leadframe and the substrate.

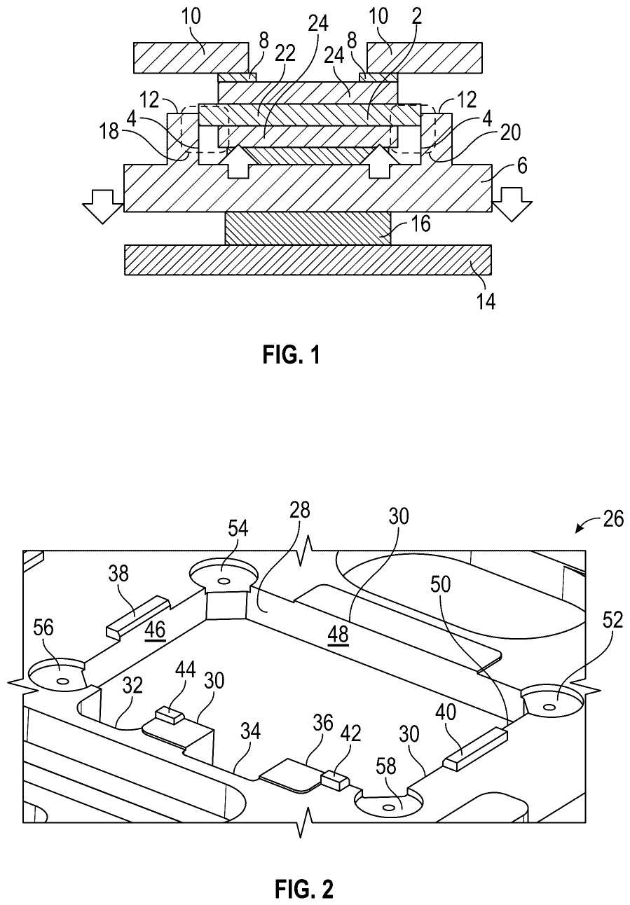

In order to provide mechanical support to the leadframe and substrate during the reflow operation and aid in creating consistent process outcomes, various jigs are employed in various method implementations. Referring to FIG. 1, a side cross sectional view of a semiconductor substrate (substrate) 2 coupled in a pocket 4 of a reflow jig 6 is illustrated following reflowing of solder 8 to form a bond with leadframe 10. During the reflow, the top edge 12 of the reflow jig 6 supports the leadframe 10 as the solder 8 is melted and then cooled. FIG. 1 illustrates an intermediate positions of the substrate 2 as the reflow jig 6 is placed over a release (ejection) jig 14 which contains a projection 16 that pushes the substrate 2 out of the pocket 4 under gravity and/or bias force during cooling after reflow is completed. Because the reflow may take place at temperatures in excess of 200 C, if the ejection/release is attempted before the reflow jig 6 reaches ambient temperature, the thermal expansion of the material of the reflow jig 6 can shrink the size of the pocket 4 to the point that the edges of the pocket 4 contact the edges of the substrate 2 (see the dotted regions 18, 20). This behavior may be particularly noticeable where the reflow jig is made of aluminum or an aluminum alloy.

In the implementation illustrated in FIG. 1, the substrate 2 is a direct bonded copper substrate which includes a ceramic layer 22 between two copper layers 24. Since the ceramic layer 22 extends beyond the edges if the copper layers 24, the comparatively brittle ceramic layer 22 contacts the metal edges of the pocket 2 during the release which can cause chipping and cracking of the ceramic layer. If the chipping/cracking does not immediately cause failure of the resulting semiconductor package, it can cause reliability failures in the field which makes the defects significant. The reflow jig 6 has pocket edges that are oriented about 90 degrees from vertical (direction of ejection/release) or substantially parallel with a plane formed by the edges of the ceramic layer/substrate. This arrangement unfortunately maximizes the possible surface area of the pocket that could contact the substrate during ejection/release and thus increases the likelihood of chipping/crack formation during reflow processing.

Various shapes and structures of reflow jigs and pockets of reflow jigs are disclosed herein along with various methods of forming reflow jigs. While the various drawings show detail view of the structure of a single pocket, it is understood that a reflow jig may include more than one pocket that also includes the illustrated structure in the form of 2-up, 3-up, 4-up, 5-up, 6-up or larger designs.

Referring to FIG. 2, an implementation of a reflow jig 26 with a pocket 28 in a perspective view is illustrated. The pocket 28 includes various components adjacent to an opening 30 of the pocket 28 which are included as components of the pocket 28. As illustrated, the opening 30 includes two reentrant openings 32, 34 in a side 36 which begin on the side 36 and end on that same side 36 of the opening 30. It has been observed that the presence of the two reentrant openings 32, 34 on the same side provides unbalanced support to a substrate placed in the pocket and thus increases the observed rotation of the substrate in the pocket during processing. Also, the two reentrant openings 32, 34 cause unbalanced thermal expansion of the pocket 28 due to the difference in the amount of material of the pocket 28 on the side 36 relative to the other sides which contributes to the rotation/movement of the substrate in the pocket during the reflow operation.

Other portions of the pocket 28 illustrated in FIG. 2 include guides 38, 40, 42, 44 which aid the insertion of a substrate into the pocket and also assist during the ejection/release with keeping the substrate in a desired orientation. As can be observed in FIG. 12, the portion of the guides 38, 40, 42, 44 that meets the edge of the opening 30 is in the same plane as the sides 36, 46, 48, 50 of the opening 30 which are oriented substantially vertically/perpendicular to the edge of a substrate placed in the opening 30. This vertical orientation of the sides 36, 46, 48, 50 and the corresponding portions of the guides 38, 40, 42, 44 means that the surface area of the pocket 28 available to hit/impact the substrate during ejection/release is maximized.

The pocket 28 also includes corner openings 52, 54, 56, 58 which are located at corners of the pocket 28 in which rest the corners of a substrate during the reflow operation. FIG. 6 is a top view of the corner opening 56 which shows that on each side 60, 62 of the corner opening 56, a square/90 degree edge is present. This square edge on each side 60, 62 where the arc portion of the corner opening 56 transitions to each side 46, 36 of the opening 30 has been observed to create point contact stresses at these locations on the substrate during reflowing and ejection/release operations, which can cause damage to the substrate.

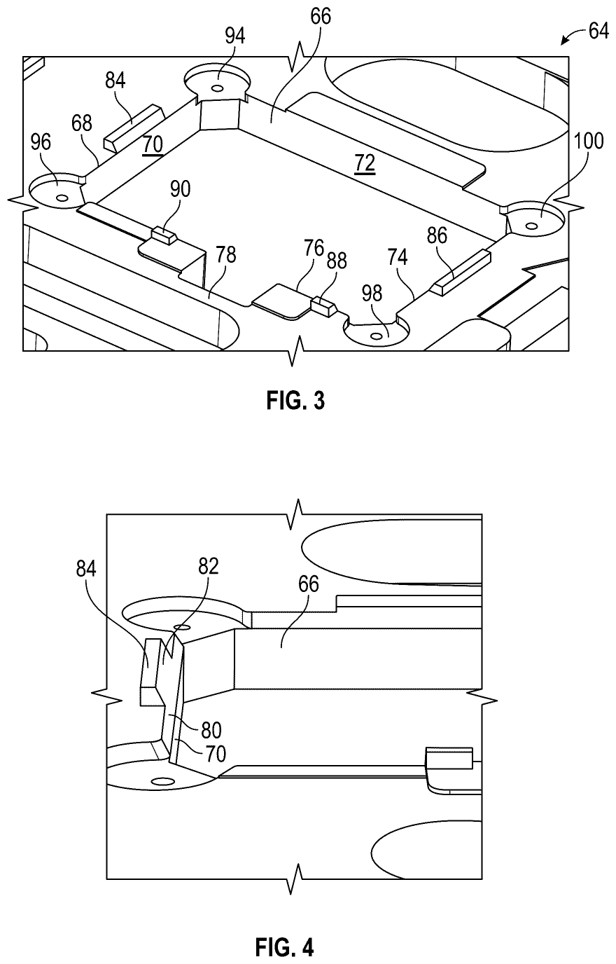

Referring to FIG. 3, another reflow jig 64 is illustrated that shows pocket 66. Pocket 66 includes opening 68 that has sides 70, 72, 74, 76. As illustrated, the opening 68 includes only one reentrant opening 78 therein. This has the effect of minimizing the unbalanced support and difference in amount of material of the pocket 28 which is on each side 70, 72, 74, 76. This use of the single reentrant opening 78 serves to help reduce the rotation of substrates during the reflow processing and also helps reduce movement of the substrate due to thermal expansion. This reduction of rotation and movement helps prevent contacting of the substrate against the sides 70, 72, 74, 76 which helps reduce the likelihood of chipping/cracking.

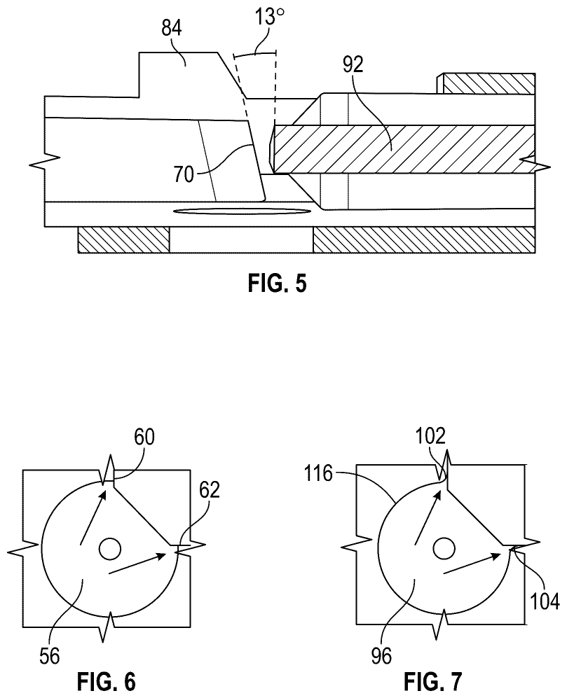

FIG. 4 is a different perspective view of the side 70 of the pocket 66 that shows how an upper portion 80 of the side 70 is angled, as is the corresponding portion 82 of the guide 84. This angled portion and angled portion of the guide differ from the configuration of the pocket 28 illustrated in FIG. 2 and work to aid in the release of the substrate from the pocket during the ejection/release process using the ejection jig. The angle of this upper portion 80 and corresponding portion 82 of the guide 84 is referred to as a release angle. Testing has indicated that the release angle is affected by the material type of the reflow jig. Where the reflow jig is made of titanium, a release angle as small as about 7 degrees has demonstrated successful results in preventing chipping/cracking defects in the substrates. However, where aluminum is used as the material for the reflow jig, the release angle that ranges between about 10 degrees to about 13 degrees works better. This is at least in part because the coefficient of thermal expansion of aluminum is larger than the coefficient of thermal expansion of titanium. The difference in coefficients of thermal expansions means that a greater separation via the release angle for the aluminum pocket is needed to achieve the same performance as that observed from a titanium pocket. As illustrated in FIG. 4, the release angle is applied to the upper portion of all four sides 70, 72, 74, 76 of the pocket 66 around the opening 68 and to each guide 84, 86, 88, 90. FIG. 5 illustrates how the release angle is measured and applied to the structure of the side 70 and guide 84 and how the relationship between the substrate 92 is relative to the side 70 when the substrate 92 is supported in/resting in the corner pockets 94, 96, 98, 100 (see FIG. 3) during the reflow operation.

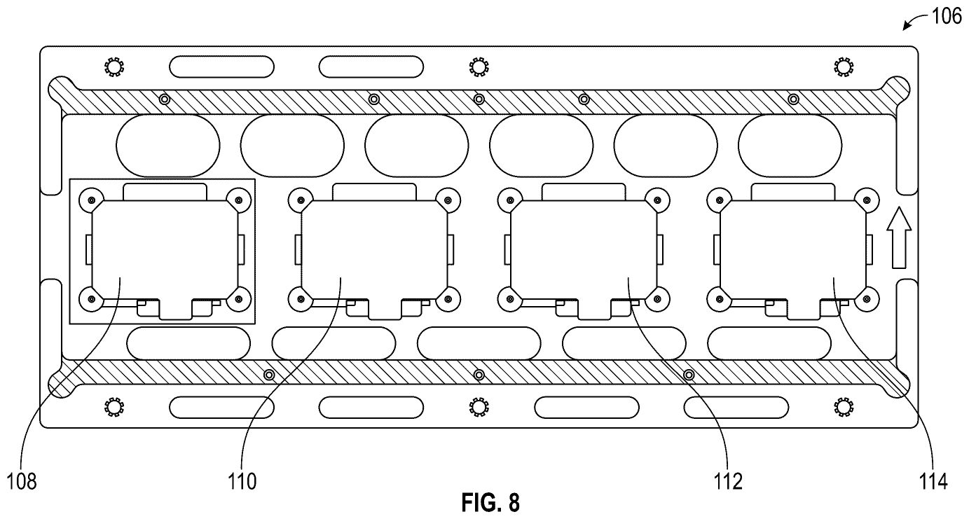

While the use of the release angle can be applied alone to a pocket to achieve a reduction of chipping/cracking defects in particular implementations, in some implementations, the release angle is combined with the single reentrant opening 78 previously discussed and with a modification to the corner openings. In some implementations, however, the single reentrant opening 78 may be omitted and the double reentrant openings of FIG. 2 may be retained. Referring to FIG. 7, a top view of the corner opening 96 of FIG. 3 is illustrated. Comparing the design with the one illustrated in FIG. 6, it can be observed that a chamfer has been added to each side 102, 104 of the corner opening 96, forming a rounded edge. In contrast, the sides 60, 62 of the corner opening 96 have a square edge as previously described which increases the proximity of the sides 60, 62 to a substrate corner placed in the corner opening. The arc 116 of the corner opening is coupled to/meets the rounded edge. The use of the chamfer to create a rounded edge results in increasing the distance between the sides 102, 104 from the substrate corner placed in the corner opening. Accordingly, the likelihood of a collision between the sides 102, 104 during the ejection/release process and the substrate corner is reduced which correspondingly reduces the odds of formation of a chip/crack defect.

Referring to FIG. 8, a top view of a reflow jig 106 is illustrated that shows four pockets 108, 110, 112, 114 formed therein each of which include the combination of the previously described release angle, single reentrant opening, and chamfered corner openings. This particular reflow jig 106 is a 4-up design that is able to process four substrates and leadframes through the reflow soldering operation followed by use of a release jig to eject/release the substrates/leadframes from the reflow jig 106. More pockets or fewer pockets could be included in various reflow jig implementations.

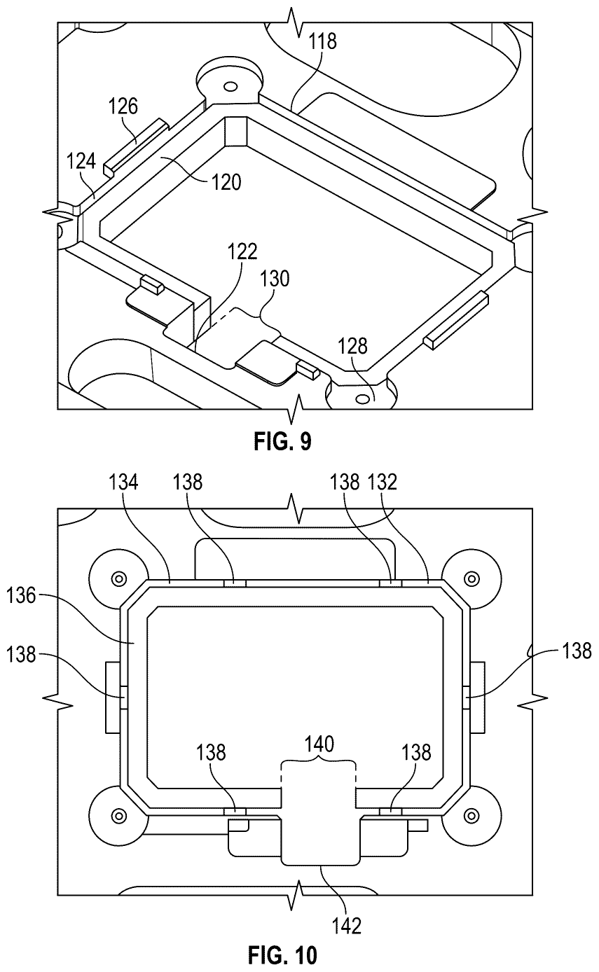

In various reflow jig implementations, the use of a soft/resilient/pliant material in a frame coupled into the opening of the pocket may be used to help mitigate chipping/cracking defects during the reflow process. The use of the frame may be used in combination with none, one, all, or any of the previously mentioned pocket designs illustrated in the pocket implementation of FIG. 3. In other implementation, however, only the frame may be employed in the pocket design of FIG. 2 which omits any of the previously mentioned pocket designs. Referring to FIG. 9, an implementation of a pocket 118 that includes frame 120 coupled therein is illustrated. Frame 120 is formed of a pliant material which may be, by non-limiting example, a high temperature rubber, a polyimide, a silicone, any combination thereof, or any other soft/resilient material that can withstand the temperatures of the reflow process. In the implementation illustrated in FIG. 9, the frame 120 is held in place against the sides of the pocket using friction force. However, in some implementations, a glue or adhesive could be used to hold the frame in place, though this option would limit the ability to as easily exchange the frame 120 when the material of the frame became damaged or worn. The particular pocket design of the pocket 118 includes the single reentrant opening 122, a release angle on the upper portions of the sides 124 and guides 126, and the use of chamfered pocket openings 128 like those disclosed in this document. As a result, the frame 120 includes gap 130 in the material of the frame at the reentrant opening 122.

In other pocket implementations, the frame may be coupled into the opening of the pocket using springs. Referring to FIG. 10, a top view of an implementation of a pocket 132 with opening 134 is illustrated where frame 136 is supported/coupled in the opening 134 using springs 138. The springs 138 are welded to the sides of the opening and retain the material of the frame 136 in place using a spring bias force. Like the frame implementation 120 illustrated in FIG. 9, the frame 136 includes a gap 140 adjacent to the single reentrant opening 142 included in this pocket 132 implementation. The use of springs may be utilized with none, one, any, or all of the previously described pocket designs (release angle, single reentrant opening, or chamfered corner openings).

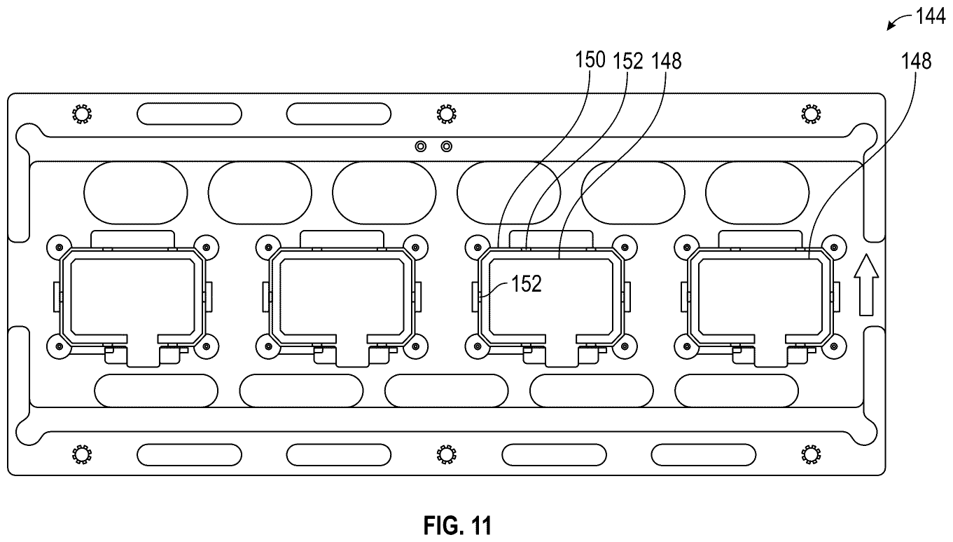

The use of frames in pockets may be applied in various reflow jig designs. FIG. 11 illustrates a 4-up reflow jig 144 that includes frames 148 held in openings 150 using springs 152. Various reflow jig implementations may include more or less pockets to allow for processing of more or fewer substrates using the frames in the pockets. The use of the frames with the pliant material may help mitigate the effect of thermal expansion on the substrates and/or prevent any significant physical contact between the substrate and the hard metal of the pocket itself. In this way, the frames 148 help prevent chipping/cracking defects like those previously described from being formed. The use of the frames with pliant material in combination with none, one, any, or all of the previously described pocket design elements may further help reduce the likelihood of chipping/cracking defects in various implementations.

In places where the description above refers to particular implementations of jigs and implementing components, sub-components, methods and sub-methods, it should be readily apparent that a number of modifications may be made without departing from the spirit thereof and that these implementations, implementing components, sub-components, methods and sub-methods may be applied to other jigs.

1. A jig comprising:
at least one pocket comprising:
an opening through a thickness of the jig;
a plurality of chamfered corner openings, each of the plurality of chamfered corner openings located at a corner of the at least one pocket arranged around the opening; and
angled sides of the opening, wherein the angled sides extend to a top of a sidewall of the at least one pocket;
wherein the at least one pocket is formed in a body portion of the jig.

2. The jig of claim 1, wherein an angle of the angled sides is 13 degrees from vertical.

3. The jig of claim 1, wherein a chamfer on each side of the plurality of chamfered corner openings comprises a rounded edge.

4. (canceled)

5. The jig of claim 1, wherein a guide disposed along an edge of the opening comprises a completely angled side.

6. The jig of claim 5, wherein an angle of the completely angled side is 13 degrees from vertical.

7. A jig comprising:
at least one pocket comprising:
angled sides around an opening, an angle of each of the angled sides being 13 degrees from vertical;
wherein the at least one pocket is formed in a body portion of the jig and configured to receive a semiconductor substrate therein during a reflow process.

8. The jig of claim 7, further comprising at least one chamfered corner opening located at a corner of the at least one pocket.

9. The jig of claim 8, wherein a chamfer on a side of the at least one chamfered corner openings comprises a rounded edge.

10. The jig of claim 9, wherein the at least one chamfered corner opening comprises an arc coupled with the rounded edge.

11. (canceled)

12. The jig of claim 7, wherein a guide disposed along an edge of the opening comprises a completely angled side.

13. The jig of claim 12, wherein an angle of the completely angled side is 13 degrees from vertical.

14. The jig of claim 12, further comprising three guides disposed along edges of the opening, each guide of the three guides comprising a completely angled side.

15-20. (canceled)

21. A jig comprising:
at least one pocket comprising:
an opening through a thickness of the jig;
a plurality of chamfered corner openings, each of the plurality of chamfered corner openings located at a corner of the at least one pocket arranged around the opening; and
angled sides of the opening;
wherein the at least one pocket is formed in a body portion of the jig; and
wherein each of the plurality of chamfered corner openings comprise at least one square edge wherein an arc portion of the plurality of chamfered corner openings transitions to a side of the opening through the thickness of the jig.

22. The jig of claim 21, wherein an angle of the angled sides is 13 degrees from vertical.

23. The jig of claim 21, wherein a chamfer on each side of the plurality of chamfered corner openings comprises a rounded edge.

24. The jig of claim 21, wherein a guide disposed along an edge of the opening comprises a completely angled side.

25. The jig of claim 24, wherein an angle of the completely angled side is 13 degrees from vertical.
